(19) United States
(12) Patent Application Publication
(10) Pub. No.: US 2024/0366465 A1
(43) Pub. Date: Nov. 7, 2024

(54) HAND/FINGER EXPANDER DEVICE

(71) Applicants: John Abramowicz, Mississauga (CA); Caroline Quartly, Mississauga (CA)

(72) Inventors: John Abramowicz, Mississauga (CA); Caroline Quartly, Mississauga (CA)

(21) Appl. No.: 18/652,518

(22) Filed: May 1, 2024

Related U.S. Application Data
(60) Provisional application No. 63/499,353, filed on May 1, 2023.

(51) Int. Cl. A61H 9/00; A61H 23/02

(52) U.S. Cl. CPC A61H 9/0092; A61H 23/02; A61H 2201/0153; A61H 2201/105; A61H 2201/1246; A61H 2201/1657; A61H 2201/1688; A61H 2201/5002; A61H 2201/5005; A61H 2205/067

(57) ABSTRACT

Apparatus for use by a person is disclosed and comprises: a body having a collapsed position adapted for insertion into a tightly clenched fist of the person and an expanded position which closely approximates the natural shape of the metacarpal arch of the person; and a mechanism which causes the body to move between the collapsed and expanded positions in a slow, oscillating manner. The movement of the body is such that the body directs extension of all finger joints along their normal, biomechanically correct axes of rotation.

### CROSS-REFERENCE TO RELATED APPLICATIONS

This application claims priority to U.S. Provisional Patent Application Ser. No. 63/499,353, filed May 1, 2023.

### BACKGROUND OF THE INVENTION

### 1. Problem Statement: The Clenched Fist

The clenched fist in medicine embraces a spectrum of impairment that ranges between minor transient hyperflexed digits, hypersensitive facilitated grasp reflexes, dystonic movement disorders, and the more extreme non-manually reducible contracted and painful fisted hand and fingers. In the clenched fist, the joints and tendons may be fixed and/or contracted to variable degrees; the skin may be atrophic, friable, and/or scarred; the grasp reflex may be facilitated and extreme: there may be unopposed muscle spasm and/or spasticity. There may be atrophy of disuse and/or nerve injury. There may be bacterial and fungal overgrowth and a foul and/or putrid odor. There may be pressure ulcers with or without nails sticking into the palm (and in the extreme, grade 4 ulceration with infection down to bone). And above all, there is pain. With that pain, there may be cognitive impact, particularly in the patient suffering dementia. In extreme form, the clenched fist poses an extraordinary challenge to nursing care, representing a state of inhumaneness for long-term care residents so affected, and causing difficulty for the staff caring for such patients (as trying to clean their hands creates such excruciating pain).

The medical conditions leading to the clenched fist include (but are not limited to) neurological and musculoskeletal pathologies such as stroke, cerebral palsy, Parkinson's disorder, acquired brain injury with or without trauma, dementia (with hyper facilitated grasp reflex), arthritides, soft tissue injury with skin, tendon, and ligament disruption/contracture.

Recommendations for managing the clenched fist consistently emphasize the necessity of multidisciplinary input. However, due to the current economic climate, the ideal resources are largely unavailable to the majority of individuals in Canada who require them. Additionally, even when accessible, these resources typically offer short-term solutions without addressing the underlying pathology, leaving patients in a constant state of vulnerability.

In recent years, the introduction of botulinum toxin has provided a means to facilitate the opening of the clenched fist for essential nursing care, including palm and digit cleaning and nail trimming. However, the logical approach to treatment, which involves complementing the effectiveness of botulinum toxin with access to a multidisciplinary team capable of consistently providing range of movement therapy, is in reality not available.

Furthermore, significant barriers exist regarding the availability and success of adequate and appropriate splinting, whether for maintaining improved range of movement or preventing further contracture. Practical limitations hinder the provision of sufficient education for care aides, often resulting in improper splint application. This can potentially worsen the development of pressure ulcers if worn for extended periods without adequate attention to skin integrity. Consequently, even these potentially minimally effective strategies are not fully integrated.

Functional Limitations: A clenched fist due to multiple pathologies severely restricts the hand's functionality. The ability to grasp objects, perform intricate tasks, and engage in daily activities is compromised. This limitation significantly impacts the individual's quality of life, independence, and ability to participate in society.

Health Consequences: Beyond functional limitations, prolonged clenched fist posture can lead to secondary health issues such as muscle stiffness, joint pain, and even contractures. These complications can exacerbate existing pathologies, leading to further disability, and reducing overall well-being.

Psychological Impact: The psychological impact of a clenched fist should not be overlooked. It can result in frustration, decreased self-esteem, and social withdrawal. Addressing these pathologies not only improves physical function but also contributes to the individual's mental health and overall sense of well-being.

Economic Burden: There is also an economic burden associated with untreated or inadequately managed pathologies leading to a clenched fist. This includes healthcare costs related to managing complications, rehabilitation services, and potential loss of productivity for both the individual and society as a whole.

### BRIEF DESCRIPTION OF THE FIGURES

FIG. 1 is a photograph showing a device according to an example embodiment of the invention assembled and partially disassembled.

FIG. 2 is a series of photographs showing Patient 1: Right and left hand contracture, Botox injection, Hand Expander Use. Result one hour after commencement of treatment.

FIG. 3 is a series of photographs showing Patient 1—Result of botox and hand expander use, 1 hour after commencement of treatment: Passive increased of finger extension achieved. Blackened nails uncovered on left hand.

FIG. 4 is a series of photographs showing patient 1 three months following the photographs of FIG. 3. Finger extension preserved.

FIG. 5 is a series of photographs showing Patient 2.

FIG. 6 Patient 3, first session with hand expander and botox.

### DESCRIPTION OF THE INVENTION

Innovation and Solutions: there is a clear need for novel approaches to improve outcomes for individuals affected by clenched fist-related pathologies. The introducing of an innovative solutions to address these pathologies holds significant promise.

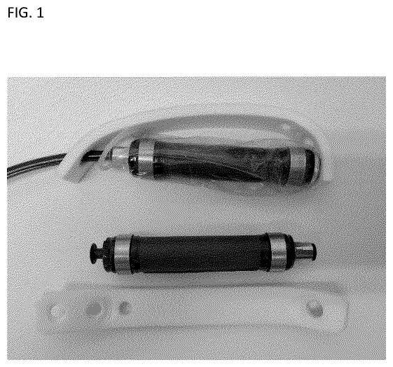

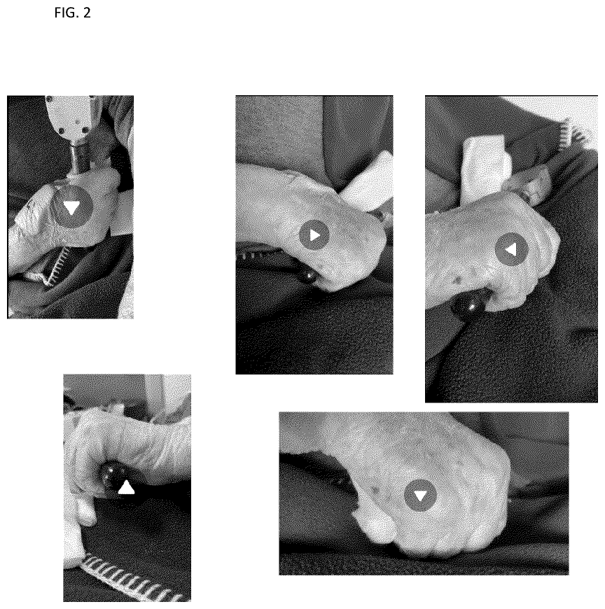

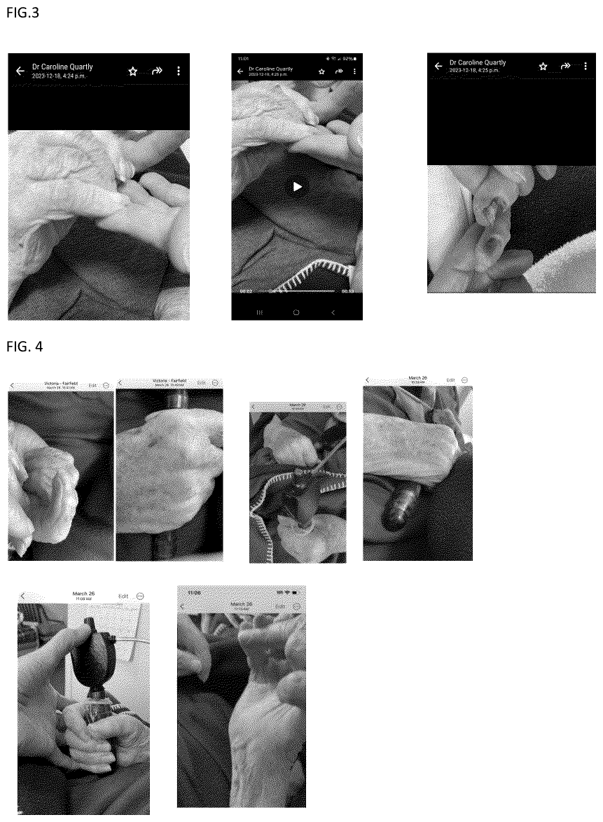

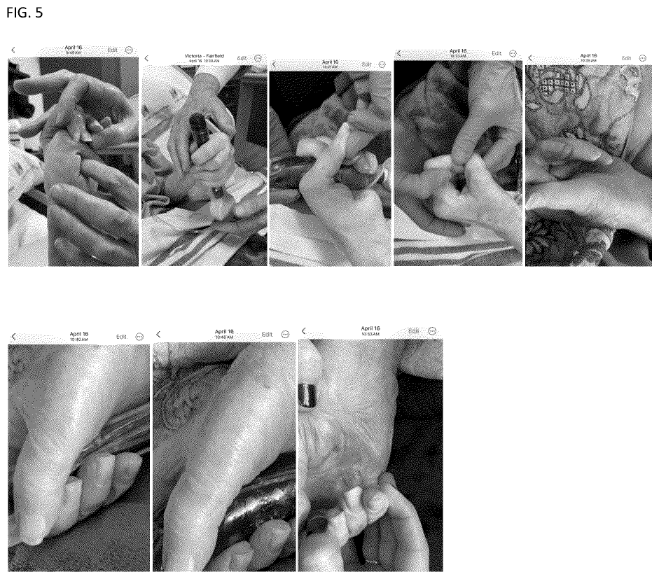

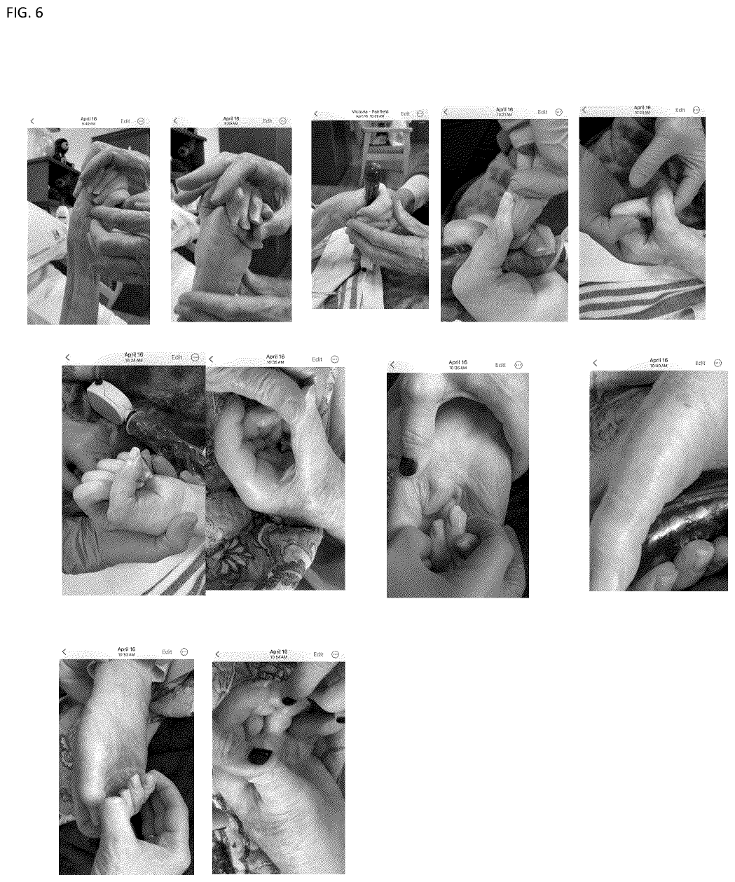

The fingers/hand device incorporates fundamental nonpharmacological strategies that are known to be effective in modulation of pain and facilitation of function: Application of vibration of variable frequencies; application of gentle rhythmic and sustained range of movement that specifically does not cause microtrauma and its stretching application. The finger/hand expander is shown in FIG. 1 and consists of 2 components: A wand (which contains the vibration component) and an expandable bladder which is under pneumatic pump control to achieve increases opening of the hand and digits.
Use of nonpharmacological strategies: The device focuses on nonpharmacological approaches for pain control and for muscle relaxation. This is particularly emphasized in a population where minimizing long-term medication usage and concerns about side effects or dependency are of paramount importance.
The incorporation of variable-frequency vibration is a notable feature. Vibration therapy has been shown to have analgesic effects and can help improve local circulation and reduce muscle tension. This feature offers a potentially effective method for pain management.
The emphasis on gentle and prolonged rhythmic range of movement without causing microtrauma during gentle stretching is critical. This approach aligns with principles of rehabilitation and injury prevention facilitating healing and functional recovery without exacerbating pain in the process of achieving increased movement.
By highlighting the effectiveness and pain modulation and facilitation of function I highlight the devices primary objectives. This clarification is for users and healthcare professionals evaluating the potential benefits and suitability of this device for addressing specific medical needs.

### Overview

The example embodiment is a rigid, cylindrical object designed to be inserted into a tightly clenched fist in a neurologically compromised patient suffering from spasticity or other condition which causes a stiff, finger flexion deformity. The cylindrical shape is expanded using air pressure generated by a microprocessor-controlled air pump to cause finger and thumb extension in a slow, oscillating manner.
The 4.5- to 5-inch-long rigid cylinder has a diameter of % inches is drilled at one end to accept a 10-32-inch barrel nut installed in an inverted position to provide an anchor point for a 1×6 inch foam strap. The rigid cylinder is covered by an elastomeric sleeve of the same length and diameter. The elastomeric sleeve has a thickness of approximately 0.025 inches. The sleeve is hermetically sealed and fixed at both ends of the rigid cylinder using soft, metallic crimp rings. The elastomeric sleeve is inflated by virtue of air pressure of approximately 10-12 psi being applied through a ¼ inch O.D. flexible urethane hose inserted into a ¼″×⅛ NPT quick connect fitting attached to a drilled, threaded channel through one end of the rigid cylinder. The drilled channel terminates at the approximate midway point of the rigid cylinder and, by virtue of drilled opening in the sidewall of the rigid cylinder into the terminus of the previously described channel, vents directly into the narrow air space between the rigid cylinder and elastomeric sleeve.
The expanded shape of the expanded sleeve closely approximates the natural shape of the human metacarpal arch and directs extension of all finger joints along their normal, biomechanically correct axes of rotation.
For patient hygiene and infection control between different users and for ease of insertion into the clenched hand, the device is to be used with a disposable, small diameter elastomeric oversleeve used in conjunction with physiologically compatible, water-based lubricants.

The performance of the device is described in Section 3. Through this demonstration, it will become clear that the device's components, including vibration frequency, range of bladder expansion, rhythmic opening and relaxing, and application frequency, can all be adjusted. This flexibility will allow for tailored treatment protocols to address less severe conditions as needed. Additionally, by identifying contracture risk early, modifications can be made with specific protocols to prevent long-term consequences and alleviate pain.

### Typical Use of the Device in the Severely Compromised Patient:

### Assessment and Administration of Botulinum Toxin (BTX):

The patient undergoes a thorough clinical assessment to determine suitability for botulinum toxin treatment.
Informed consent is obtained, and treatment goals are established.
Target muscles contributing to the clenched fist are selected, and the appropriate quantity of botulinum toxin is ordered.
BTX is administered to the preselected muscles in the forearm and hand according to standard protocol.
The hand and fingers are assessed for any initial relaxation or loosening of clenching post-injection.

### Application of Vibration:

The wand component of the fingers/hand expander, protected with an elastomeric sleeve, is positioned at the opening of the curled fifth digit (small finger) and the palm to initiate relaxation with gentle vibration.
As the patient becomes more comfortable, the wand is gradually and gently inserted into the clenched fist.
Initially, low-frequency vibration is used for pain modulation, with the frequency adjusted as needed.
   1. research suggests that frequencies within the range of 50 to 200 Hz are commonly used for pain management purposes.
   2. Lower frequencies (around 50-100 Hz) are thought to stimulate the large diameter Aβ fibers, which can inhibit the transmission of pain signals through the spinal cord. This mechanism is known as the “gate control theory” of pain modulation.
   3. On the other hand, higher frequencies (around 100-200 Hz) may activate smaller diameter Aδ and C fibers, leading to the release of endorphins and other neurotransmitters that can reduce pain perception.
The haptic motor in the hand expander wand is energized utilizing the motor controller module and set to a gentle vibration intensity (approximately 140 Hz).
Once fully inserted, the vibration intensity is increased to facilitate relaxation of the clenched fist.
The vibrating wand is maneuvered to ensure all fingers grip it, with insertion depth and rate adjusted based on the severity of finger grip and patient pain levels.

### Application of Cyclic Inflation/Deflation of the Elastomeric Sleeve Compartment:

After sufficient vibration and finger mobility, the elastomeric sleeve is inflated and deflated using the hand expander controller/pneumatic pump.
A controlled flow rate and limited volume of air are used to partially inflate the sleeve, promoting gentle finger extension/grip expansion.
Cyclic inflation/deflation is maintained for a specified duration (approximately 20 to 30 minutes) to assess its efficacy on the patient's hand-finger postures.

### 3. Experimental

A 94-year-old woman with dementia presented with severe cognitive impairment and a one-year history of bilateral clenched fists. She had immense difficulty tolerating any movement of her fingers. The degree of her hyperflexion contracture was such that the nails were not visible, and it was not possible to open the fingers. The hands had a foul odor. The patient winced with any attempt to open the fingers. The care aides were not able to clean her palm or even to insert gauze into the palm to help absorb moisture. The patient was nonverbal and completely dependent for all activities of daily living. She was referred for the suitability of injecting botulinum toxin to manage progressive contracture of bilateral clenched fists. The purpose was to improve hand hygiene, mitigate pressure ulcers, decrease pain, and facilitate ease in nursing care. She had a history of arteriopathy, atherosclerotic coronary artery disease, hypertension, and cerebrovascular accident. She had known lacunar infarcts in the left basal ganglia, presumed lumbar spinal stenosis, and presumed multi-infarct dementia. She had been nonverbal for well over a year and had an extremely strong grasp reflex. Any attempt to open her hands was met with wincing and withdrawal. The nails were not visible as the fingers were tightly curled at the distal interphalangeal joints and the PIP joints (maximally tightly fisted). The odor from both hands was foul. She was nonverbal, her eyes were closed, and there was no evidence of elbow flexion contracture or of shoulder adduction contracture. The thumb was adducted bilaterally, and the interphalangeal joint was flexed but reducible. The fisted attitude of both hands was nonreducible.

She had been in full care at another facility before entering the present LTC. She had previously been assessed to need botulinum toxin for severe contracture and had been awaiting physician intervention at the previous facility for some 6 months prior to being referred to me. Botulinum toxin was ordered after talking to her medical power of attorney and securing informed consent. I also discussed the possibility post botulinum toxin use of the vibration and finger/hand expander.

At her initial appointment, 300 units of botulinum toxin reconstituted and 6 cc of normal saline without preservative were injected in divided doses into the target muscles in both forearms and hands contributing to bilateral clenched fists.

After the botulinum toxin was injected initially, there was minimal relaxation of the fingers, and it was not possible to open the fingers. The patient had a strong withdrawal and tight grasp bilaterally. The vibration wand was introduced from the lateral aspect of the right hand (from the space between the thumb and the curled index finger). She did not tolerate the wand in the medial aspect of the hand (between the palm and the curled fifth digit). The vibration wand appeared to have an immediate calming effect and was slowly introduced through the lateral side into the palm.

With the vibration wand in place, the right hand was prepared for botulinum toxin injection, following which it was not possible to open the digits.

The vibration with the wand had been tolerated in the right hand for approximately 15 minutes when the inflation/deflation was turned on. By this time, the wand was fully through the palm, and visible gentle movement of the hand was continued rhythmically for another 15 to 20 minutes. The process was well-tolerated and even appeared to be relaxing. There was no evidence of pain.

Attention was then drawn to the left hand, with the vibration wand inserted from the lateral aspect and able to be advanced without difficulty. After about 10 minutes of vibration on the left, the finger/hand expansion component was turned on. A greater degree of opening was achieved on the left. What was surprising was that the fingernails became visible, and the middle finger of the right hand could then be opened a full 1½ cm from the palm. So, the bladder rhythmic expander was turned on for the right hand for the 20 min that the vibration wand was used on the left.

What was truly remarkable was that the fingers were opened without pain to between 3 and 4 cm from the palm. What was remarkable on the left was that the tips of the fingers were now visible, and it was clear that there was what looks like a middle finger subungual hematoma, blackened nail, and adjacent digit lateral discoloration, and grade I pressure of lateral pulp [the appearance is of threatened necrosis]. With just Botox on the initial injection, I would not have been able to see the state of the middle finger digit. The left hand was quite a bit more relaxed about 40 minutes later (which I am hoping means she will have a quicker and better response to the Botox and more importantly allow careful monitoring of the left middle and adjacent digit).

The family doctor's notes indicated general erythema around the nail, but no obvious pain response. No discharge. On the left hand, the 3rd nail was discolored, but no erythema, and again, no pain response. Impression mild paronychia right 3rd finger. No active Rx needed for now but will observe.

The patient attended for a follow up three months later. A surprisingly good maintenance of the positive effects from the combination of botulinum toxin and the finger/hand expander was noted, in particular, the right middle finger looked much healthier. A care aide indicated that she had observed the patient attempting to open her right hand and reach for food. There was no voluntary movement in her attendance, but the patient had maintained a surprising improvement in passive range in the hand given the severity of the previous fist clenching. Corridor consultation with the footcare nurse indicated an enormous improvement in her ability to trim the nails.

A second injection of botulinum toxin was made at this follow up appointment. A similar protocol was elicited with botulinum toxin with some modification of muscles injected according to the tightness present. The left hand was surprisingly looser. With the vibration wand and the finger expander, the unit had to be held in place but still appeared to be voluntarily soothing. The combination of vibration and expansion was used initially, and then just the finger expansion. The left hand was quite relaxed, and the degree of opening is without any strain or muscle pain or wincing or withdrawal.

On the right, after the injection, the hand was looser but only after using the combination of vibration, finger, and hand expander with the possible to identify pressure from the right middle fingernail into the palm of the hand and a break in the skin, the quality of the tissue inside the palm was friable. Between the first and second injection, there was already an improvement in the smell. Inter-dry was ordered to maintain wicking away of moisture within the hand. As the biggest difference that was noted was how much more easily the hand was able to be opened without the patient wincing or seeming uncomfortable. It was also possible to view the palm and both sides so that should the lumbrical injection have been warranted it could easily have been done. This is actually quite unusual given the degree of initial fist clenching and pain as observed 3 months earlier.

Five further patients were treated with an injection of botulinum toxin followed with the finger/hand expander and in each case the results are a minimum of 30% better than with Botulinum toxin alone.

### VARIATIONS

Whereas an example embodiment of the device is shown, and an example protocol for use of the device is described, variations are possible. Accordingly, the invention should be understood to be limited only by the accompanying claims, purposively construed.

What is claimed is:

1. Apparatus for use by a person, the apparatus comprising:
a body having a collapsed position adapted for insertion into a tightly clenched fist of the person and an expanded position which closely approximates the natural shape of the metacarpal arch of the person, and
a mechanism which causes the body to move between the collapsed and expanded positions in a slow, oscillating manner,
the movement of the body being such that the body directs extension of all finger joints along their normal, biomechanically correct axes of rotation.

2. Use of the apparatus of claim 1 by a neurologically compromised patient suffering from spasticity or other condition which causes a stiff, finger flexion deformity.

3. Apparatus according to claim 1, wherein the mechanism comprises a microprocessor-controlled air pump.

4. Apparatus according to claim 1, wherein the body has a tubular portion of about 4 to 5 inches in length and an elastomeric sleeve covering the body and sealed at the ends.
